(19) United States
(12) Patent Application Publication
(10) Pub. No.: US 2026/0156438 A1
(43) Pub. Date: Jun. 4, 2026

(54) WIRELESS NETWORK DATA COLLECTION AND MANAGEMENT FOR MOBILE PERSONAL AMBIENT ENVIRONMENTS

(71) Applicant: AT&T Intellectual Property I, L.P., Atlanta, GA (US)

(72) Inventors: Gregory W. Edwards, Austin, TX (US); Robert Koch, Norcross, GA (US); James H. Pratt, Round Rock, TX (US); Eric Zavesky, Austin, TX (US); Robert Moton, JR., Alpharetta, GA (US); Adrianne Binh Luu, Atlanta, GA (US); Ari Craine, Marietta, GA (US)

(73) Assignee: AT&T Intellectual Property I, L.P., Atlanta, GA (US)

(21) Appl. No.: 18/964,983

(22) Filed: Dec. 2, 2024

(51) Int. Cl. H04W 4/38; H04W 64/00

(52) U.S. Cl. CPC H04W 4/38; H04W 64/00

(57) ABSTRACT

Aspects of the subject disclosure may include, for example, receiving sensor location data for one or more sensors, receiving, by the processing system, user device location information for a user device, determining a match between the user device location information and sensor location data for at least one sensor of the one or more sensors, collecting sensor data from the at least one sensor, and presenting, to the user device, information for display by the user device, the information for display indicating availability of collected sensor data from the at least one sensor. Other embodiments are disclosed.

### FIELD OF THE DISCLOSURE

The subject disclosure relates to a system and method for wireless data collection for mobile personal ambient environments.

### BACKGROUND

Users of mobile devices may be surrounded in their ambient environment by sensors of various types. The sensors collect data and other information that may be useful or interesting to the user, such as when the user is proximate the sensors. The ability to interact with such sensors may be valuable to the user.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a sensor 200 functioning within the communication network of FIG. 1 in accordance with various aspects described herein.

FIG. 2B is a block diagram illustrating an example, non-limiting embodiment of a system functioning within the communication network of FIG. 1 and in conjunction with one or more sensors such as the sensor of FIG. 2A in accordance with various aspects described herein.

FIG. 2C depicts an illustrative embodiment of a user display produced by the system of FIG. 2B in accordance with various aspects described herein.

FIG. 2D depicts an illustrative embodiment of a user display produced by the system of FIG. 2B in accordance with various aspects described herein.

FIG. 2E depicts an illustrative embodiment of a user display produced by the system of FIG. 2B in accordance with various aspects described herein.

FIG. 2F depicts an illustrative embodiment of a user display produced by the system of FIG. 2B in accordance with various aspects described herein.

FIG. 2G depicts an illustrative embodiment of a user display produced by the system of FIG. 2B in accordance with various aspects described herein.

FIG. 2H depicts an illustrative embodiment of a user display produced by the system of FIG. 2B in accordance with various aspects described herein.

FIG. 2I depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for identifying a set of available sensors for access by a user. In embodiments, the user can instruct a network node to engage with the sensors and collect data describing the ambient environment around the sensors under certain conditions, such as when the user is located proximate to the sensors. The network node may instruct the sensors, which are not normally under the control and management of the user, to collect data and store it or present it to the user in real time on behalf of the user. The user and an application may utilize a network node that serves as an ambient sensor control server. This function may be provided by a carrier provider, network provider, or other connection provider or partner of the provider. Other embodiments are described in the subject disclosure.

One or more aspects of the subject disclosure include receiving sensor location data for one or more sensors, receiving, by the processing system, user device location information for a user device, determining a match between the user device location information and sensor location data for at least one sensor of the one or more sensors, collecting sensor data from the at least one sensor, and presenting, to the user device, information for display by the user device, the information for display indicating availability of collected sensor data from the at least one sensor.

One or more aspects of the subject disclosure include receiving sensor location data for a plurality of sensors, wherein the sensor location data defines respective locations for respective sensors of the plurality of sensors, receiving user device location information for a user device, and matching the user device location information with sensor location data for one or more sensors of the plurality of sensors to identify sensors having sensor information for an environment of the user device. Aspects of the subject disclosure further include requesting sensor data from the one or more sensors of the plurality of sensors, receiving the sensor data from the one or more sensors of the plurality of sensors, and providing, to the user device, display information for producing a display on a user display of the user device, the display providing a visual representation of the sensor data, wherein the providing the display information is based on the sensor data from the one or more sensors of the plurality of sensors.

One or more aspects of the subject disclosure include receiving user device location information for a user device, determining a match between the user device location information and sensor location data for at least one sensor of a group of one or more sensors, the one or more sensors configured to collect information about an environment including a respective sensor, and communicating, to the user device, information for display by the user device for a user, the information for display indicating availability of collected sensor data from the at least one sensor.

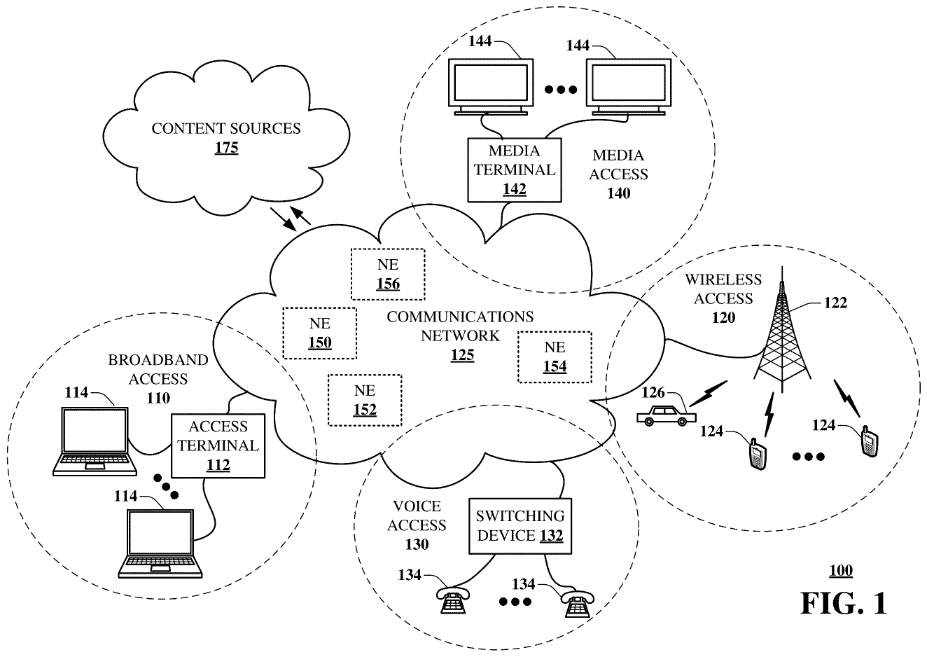

Referring now to FIG. 1, a block diagram is shown illustrating an example, non-limiting embodiment of a system 100 in accordance with various aspects described herein. For example, system 100 can facilitate in whole or in part identifying a group of sensors accessible over a network and which a user can identify and instruct the network to engage and collect data describing the ambient environment of the sensors for access by the user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

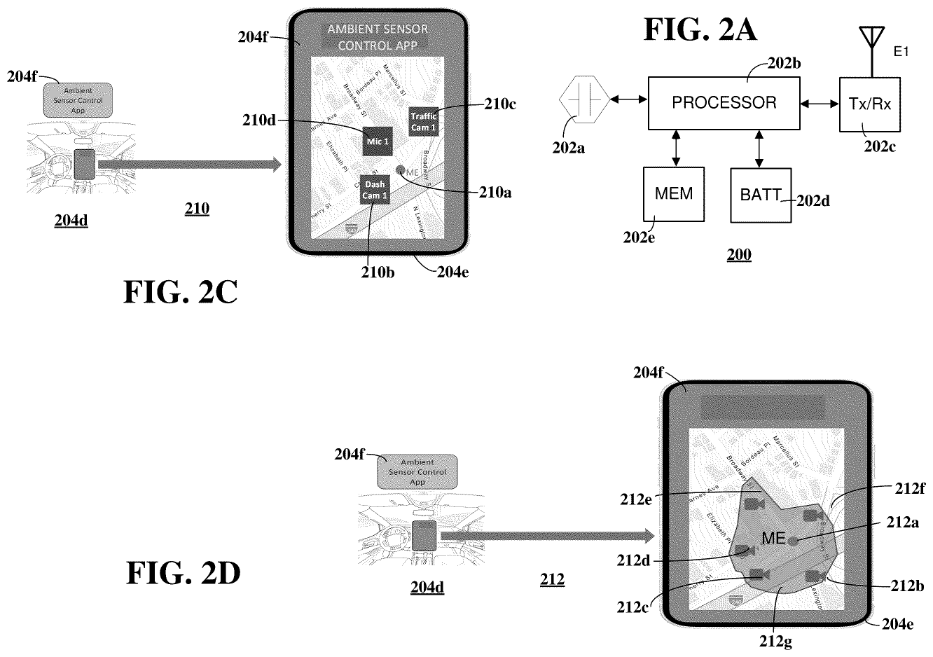

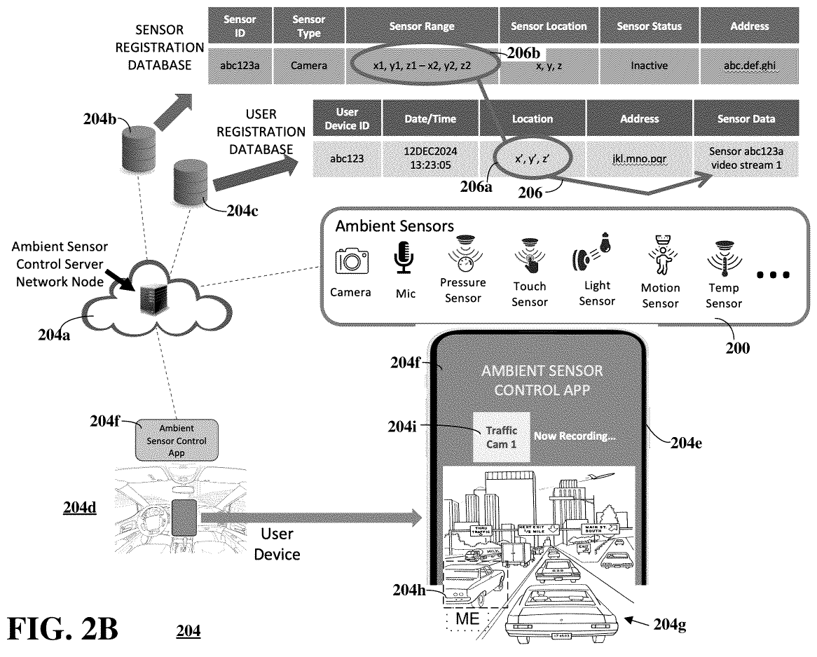

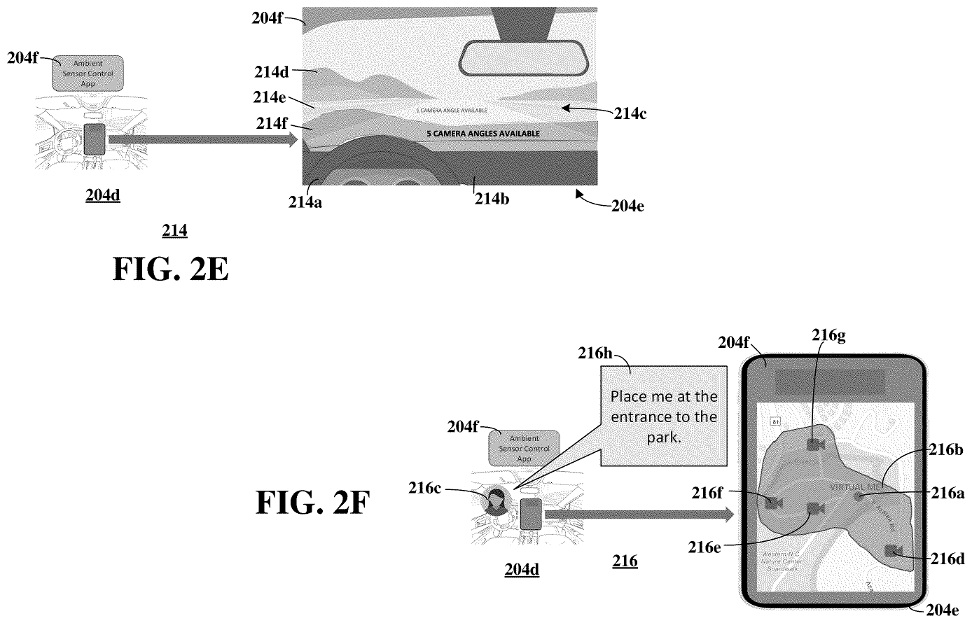

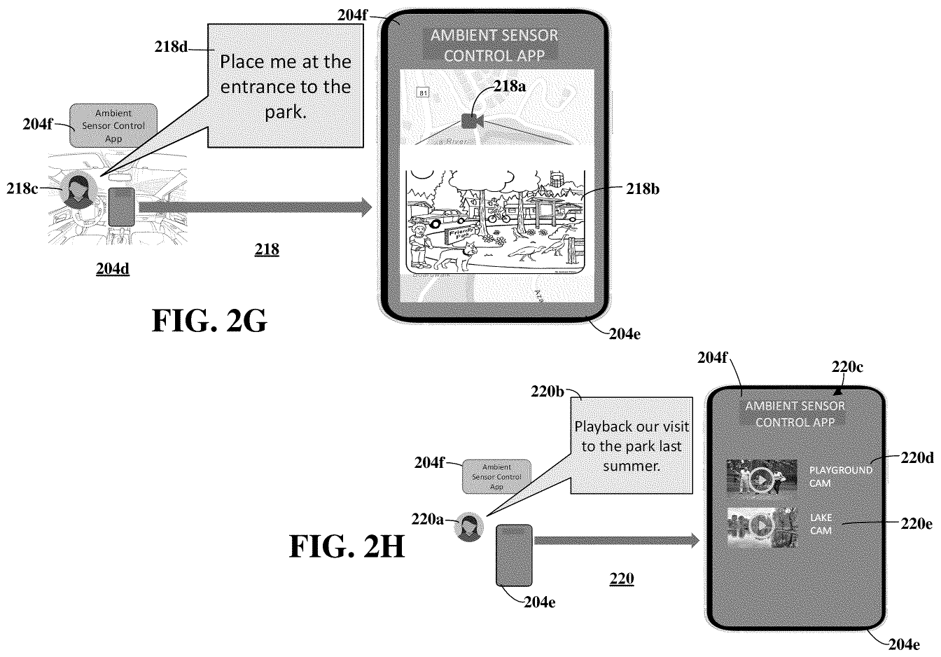

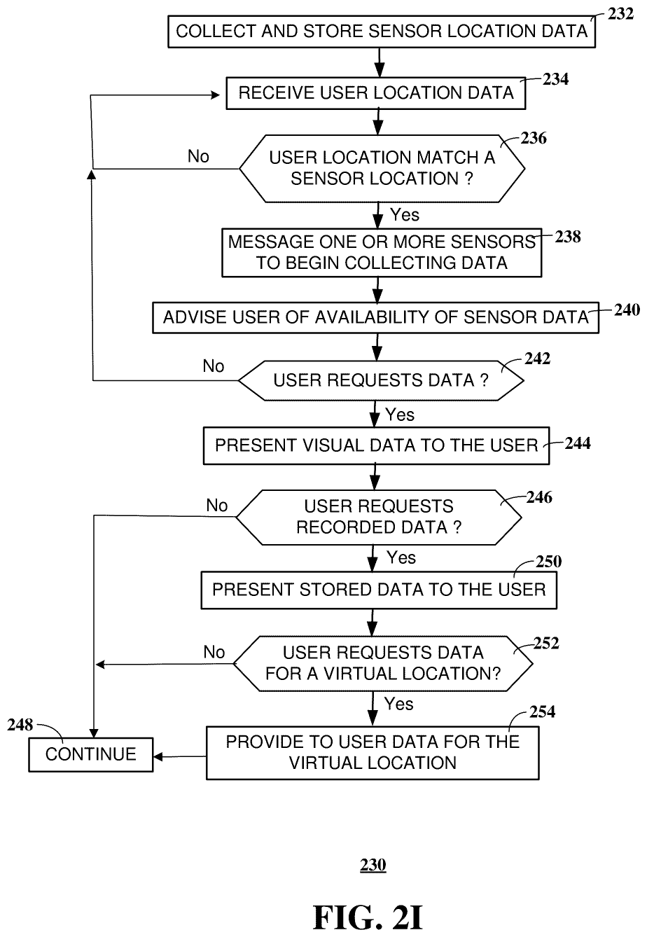

In many areas served by communication networks such as the communications network 125 of FIG. 1, there are available various sensors which collect and make available information about a location or an ambient environment. FIG. 2A is a block diagram illustrating an example, non-limiting embodiment of a sensor 200 functioning within the communications network 125 of FIG. 1 in accordance with various aspects described herein. The sensor 200 in the exemplary embodiment includes a sensor device 202a, a processor 202b, a memory 202e, and communication circuit 202c. The components of the sensor 200 may be powered by a battery 202d or other energy source. Components of the sensor 200 may be contained in a suitable housing which may, for example, provide weather resistance for outdoor applications. Other embodiments of sensor 200 may include other or additional elements for performing particular functions.

The sensor device 202a may be any device that collects information about an environment in which the sensor 200 is located. Examples of such a sensor device 202a include a camera which produces still images or video files or a video feed of a scene where the sensor 200 is located. The camera may include various types of cameras, such as image, video, infrared, thermal, and others and combinations of these. Another example of such a sensor device 202a is a microphone which is sensitive to audio in the vicinity of the sensor 200 and produces an analog signal or digital data representative of the sound.

Other examples of such sensor devices 200a measure or detect an ambient condition. One example of such a sensor device 202a is a pressure sensor which detects a pressure or force applied to the pressure sensor by another object or substance near the sensor 200 and produces an analog signal or digital data representative of the force. Another example of such a sensor device 202a is a touch sensor which detects a touch or contact, by a human or other, and produces an analog signal or digital data representative of the touch or contact. Another example of such a sensor device 202a is a light sensor that detects light or other ambient energy in the location of the sensor 200 and produces an analog signal or digital data representative of the light. Another example of such a sensor device 202a is a motion sensor which detects a motion applied to the sensor 200 and produces an analog signal or digital data representative of the motion. Another example of such a sensor device 202a is a temperature sensor which detects ambient temperature or another temperature in the vicinity of the sensor 200 and produces an analog signal or digital data representative of the temperatures. Any other type of sensor or combination of sensors may be included as the sensor device 202a.

The processor 202b may be part of a processing system which cooperates with data and instructions stored in the memory 202e to control operation of the sensor 200. The processor 202b may include one or more processors or microcontrollers or other data processing systems. The processor 202b may, for example, receive analog signals from the sensor device 202a and convert the analog signals to digital data. In other embodiments, the processor 202b may receive digital data from the sensor device 202a. The digital data may be stored in the memory 202e or provided to the communication circuit 202c. Further, the processor 202b may control functions of the sensor device 202a such as by turning on and off the sensor device 202a and modulating controllable aspects of the sensor device such as a relative sensitivity of a light sensor or touch sensor.

Further, the sensor device 202a may be associated with further control functions that may be managed by the processor 202b. In an example, the sensor device 202a includes a video camera mounted on a motor-controlled fixture that may be actuated to direct the video camera toward a selected direction. The processor 202b may receive signals from a remote source, via the communication circuit 202c, and in turn, generate control signals to actuate one or more motors and direct the camera to the selected direction. The processor 202b, or the sensor 200, may be location aware. For example, the processor 202b may receive location information from another source, such as a Global Positioning System (GPS) receiver of the communication circuit 202c, and determine location of the sensor 200 based on the location information.

The communication circuit 202c includes any suitable circuitry for communication of data and other information between the sensor 200 and a remote source or destination. In one example, the communication circuit 202c includes a cellular radio which may operate in conjunction with equipment of wireless access 120 (FIG. 1) to provide information related to the output of the sensor device 202a to a remote location over a cellular network such as a fifth generation (5G) cellular network, sixth generation (6G) cellular network or other radio network. The communication circuit 202c may also include short-range wireless communications capabilities not requiring a network, such as Wi-Fi® or Bluetooth®. Bluetooth® is a registered trademark owned by the Bluetooth Special Interest Group. Wi-Fi® is a registered trademark of the Wi-Fi Alliance. As noted, the communication circuit 202c may include a GPS or other circuit for receiving position-finding data for use in determining a location of the sensor 200. In another example, the communication circuit 202c may provide wireline communication such as over an Ethernet® connection to a remote source or destination. Ethernet is a registered trademark of Xerox Corporation.

The information communicated by the communication circuit 202c may include uplink information based on information sensed by or collected by the sensor device 202a, such as data forming a video feed from a video camera. The information communicated by the communication circuit 202c may include downlink information provided to the sensor 200 to control some aspect of the sensor 200, such as motor control signals to control a motor which directs the view of the video camera to a scene of interest or actuation signals to turn on or turn off the sensor device 202a or to control some feature of the sensor device 202a.

The battery 202d provides operating power to the components of the sensor 200. The battery 202d may be a depletable, rechargeable energy storage element. In embodiments, the battery 202 may be replaced by or may supplement a hard-wired connection to electrical mains.

Sensors such as the sensor 200 may be located in a variety of areas for collecting sensed information. The sensed information may be made available to remote destinations for use by various users. A problem exists in that users may be in the proximity of one or more different types of sensors such the sensor 200 that are available to collect data describing the ambient environment around the sensors on behalf of the user, but the user does not know of the sensors'existence and does not have control over the sensors to prompt the sensors to collect data describing the environment. Such user awareness and user control would be of benefit to the user.

FIG. 2B is a block diagram illustrating an example, non-limiting embodiment of a system 204 functioning within the communication network 125 of FIG. 1 and in conjunction with one or more sensors such as sensor 200 of FIG. 2A in accordance with various aspects described herein. The system 204 may provide a method for sensors to broadcast their availability to users under certain conditions and to make themselves available to collect ambient data on behalf of a user. A network node provides the intelligence to permit such discovery of sensors and control of sensors on behalf of the user. The network node may instruct the sensors, which are not normally under the control and management of the user, to collect data and store it, or present it to the user in real time on behalf of the user. In the example embodiment of FIG. 2B, the system 204 includes a server 204a, a sensor registration database 204b and a user registration database 204c. Further, in the example implementation of FIG. 2B, the system 204 includes a user environment 204d and a user device 204e. The system 204 interacts with one or more sensors such as sensor 200 which may be configured as illustrated in FIG. 2A.

In the example, the user environment 204d includes a vehicle such as an automobile in which the user device 204e is located. Any other user environment may be envisioned, including the user and the user device 204e being located on a street, at home, in an office, etc. The user device 204e may be any suitable device such as a smartphone or tablet computer or other wireless device. The user device 204e is location aware. Toward that end, the user device 204e may include a Global Positioning System (GPS) or other global navigation system radio receiver for determining the location of the user device 204e and, therefrom, the location of the user.

The user device 204e is in radio communication with a remote network such as a cellular network. Example cellular networks include 5G, 6G and follow-on cellular mobility networks, Wi-Fi networks and other radio networks that provide two-way data communication for the user device 204e. In the example, the user device 204e includes a radio transceiver, a processing system including a processor and memory, and a user interface. The radio transceiver provides radio communication with the cellular network or other communication network. In other embodiments, the vehicle forming the user environment 204d in this example may be, for example, a connected vehicle and include one or more radio transceivers adapted for communication. The user device 204e may access the radio transceivers of the vehicle and use other features of the connected vehicle such as an in-dash user interface.

The user interface of the user device 204e or the in-dash user interface may include, for example, a touch sensitive display or a keyboard. The display may be used for showing textual information about sensors and sensor locations and sensor data. The display may further be used for showing graphical information such as maps of a region showing, for example, the location of the user device 204e and the location of sensors such as sensor 200. The display may further be used for showing images such as photos taken by a camera sensor, a video file of images from a camera sensor or a live video feed from a camera. Views on the display may be controlled by touch-sensitive feature or an associated keyboard. The user interface may further include a speaker system for audio playback of audio detected by one or more sensors. The user interface may further include a microphone for receiving spoken commands and other audible information.

The sensor 200 is one of a group of sensors that may be part of an ambient sensor system. The group of sensors may be located throughout a sensor environment and collect information about the sensor environment. In embodiments, the group of sensors may include the ability to sense the widest range of conditions including images, video, audio, pressure, touch, light, motion, temperature and others. The sensor 200 of FIG. 2A illustrates one exemplary embodiment of sensors of the group of sensors. The sensors may be selected from the widest range of data collection devices and services and may be owned by, controlled by or operated by any suitable entity. For the example of cameras that are available as sensors, any particular camera may be a traffic camera maintained by a local police authority or a business or other entity, or doorbell cameras of residents in a neighborhood. Other examples include security cameras with a view of a particular area or entrance to a location of interest. Other examples include cameras in handheld devices, wearable cameras worn by users including smart glasses, and cameras carried on vehicles including dash cameras and surround-view cameras or 360-degree view cameras of a vehicle. Any sensor 200 may be part of the system 204 so long as the sensor 200 opts in to participate in the system and its operations and registers with the system by providing information such as that shown for the sensor registration database 204b.

In some embodiments, some or all of the sensors including sensor 200 may be made available to users as part of a business model for a service in which the user pays compensation to a business entity for access to the service and access to the information from the sensors. The service may include different tiers of access based on types of data (live or recorded) that may be accessed and based on types of sensors that may be accessed. An owner associated with one or more sensors may be compensated in some manner in return for access to the information and data from the sensors. The sensor information may be a mix of public data, such as from a traffic camera, and private data from a proprietor's sensors.

Sensors of the group of sensors may be in communication with the server 204a for implementing the ambient sensor system. The sensors may broadcast their availability to users under certain conditions and make themselves available to collect ambient data on behalf of a user. The sensors of the group of sensors may communicate with the server 204a in any suitable manner, including wirelessly and over a wireline network. The sensors may advertise their capabilities, their location and any other suitable information to the server 204a. Alternatively, the server 204a may poll the individual sensors in any suitable manner to collect necessary information from the sensors. The server 204a may in turn convey to a user and user device 204e information about sensor capabilities and location and other information.

Information from the sensors may be maintained in the sensor registration database 204b. The sensor registration database 204b may be in data communication with the server 204a over any suitable network connection. In embodiments, the information of the sensor registration database 204b may be stored and read under control of the server 204a.

FIG. 2B illustrates one example of the information that may be stored in the sensor registration database 204b. A record of the sensor registration database 204b in this example includes a sensor identifier and sensor type information defining the type of the sensor, such as camera, microphone, temperature sensor, etc. A record may further include sensor location information about the location of the sensor and range information for the sensor. The sensor location information may be determined by the sensor itself and be reported to the sensor registration database 204b, for example. The range information may define location coordinates within which the sensor is able to capture data. A record may further include a sensor status for the sensor and a network address for the sensor. For example, a status of active may indicate that the sensor is currently actively recording data; a status of inactive may indicate that the sensor is offline or not currently collecting data.

Any other suitable information about the sensor may be collected and stored at the sensor registration database 204b. For example, the sensor or the server 204a may provide and store in the database a description of the information available from the sensor and examples of the sensor information and its presentation. For example, if the sensor is a video sensor with a view of a particular location, the description field of the sensor record in the sensor registration database 204b may include a still photo of the view serving as a thumbnail photo. The still photo and other sensor description information may be provided to a user accessing the ambient sensor control application 204f.

The server 204a or other network node provides the intelligence to permit discovery of sensors and control of them on behalf of the user. The server 204a may be termed an ambient sensor control server and may form a network node on the cellular network or another data communication network. The user device 204e includes an application or app 204f. The application 204f may be termed an ambient sensor control application. The application 204f employs the network communication capabilities of the user device 204e for interacting with server 204a and other components of system 204. The user and the application 204f may utilize the server 204a as a network node that serves as the ambient sensor control server. This function may be provided by a carrier provider such as a mobile network operator (MNO), network provider, or other connection provider or partner of such a provider.

Information from the application 204f may be maintained in a user registration database 204c. In embodiments, the information of the user registration database 204c may be stored and read under control of the server 204a. FIG. 2B illustrates one example of the information that may be stored in the user registration database 204c. A record of the user registration database 204c in this example includes a user identifier associated with the user or the user device 204e, a date and a time stamp and a network address for communication with the user device. The record of the user registration database 204c may further store information about what sensor information is being currently received or has been received at the user device. The ambient sensor control application, application 204f, on the user device 204e may be used to continuously update the user's location and record user information in the user registration database 204c.

The application 204f may provide control for the user to manage the application 204f and interaction with sensors. For example, the user may use the application 204f to initiate the service provided by the server 204f and to turn on location reporting by the user device 204e. Thus, the user may use settings configurations on the ambient sensor control application 204f to indicate whether or not the user wishes to broadcast the location of the user device 204e for the purpose of identifying the availability of ambient sensors in the proximity of the user device at any point in time. Further, the user may use the application 204f to define or designate types of sensors from which to receive data. In an example, the user of the user device 204e may use the application 204f to turn off receipt of data from touch sensor and motion sensors and turn on receipt of data from cameras, microphones, light sensors and temperature sensors. The user may use the application 204f to designate an update rate that controls how frequently the user's location information is transmitted or how frequently sensor data is retrieved by the user device 204e or by the server 20aa. Reducing update frequencies may reduce the drain on the battery which powers the user device 204e, for example.

As indicated in FIG. 2B, the server 204a may determine a relationship between a user's location or the location of the user device 204e and locations of one or more sensors and the range of the sensors. Cameras are one example, but any sensor which includes an operating range encompassing the location of the user may be associated with the user based on the information in the sensor registration database 204b and the user registration database 204c.

In operation, the ambient sensor control server 204a may continually monitor and compare the location of the user with the sensor location and sensor range of each sensor registered in the database as indicated by arrow 206 in FIG. 2B. For example, the server 204a may implement a server application which monitors locations of users and locations of sensors based on information in the user registration database 204c and the sensor registration database 204b, respectively. The server application may predict a path or track of the user device 204e based on current location information and past location information. In some examples, the server application may maintain or have access to a user history database with historical information about past user activity such as a daily commute, a routine hike taken by the user or common shopping destinations. Such historical information may be used to predict the user's journey or path.

If the server application predicts or determines that a location 206a of the user device 202e is within the sensor range 206b for a sensor at a given sensor location, or approaching the sensor range, based on the predictive track of the user device, the server application may determine that the user device 204e is within range of the sensor.

Further, the server application may compare the sensor type stored in the sensor registration database 204b with sensor types defined in the configuration settings of the user or the user device 204e. If the user's configuration settings have indicated that the type of sensor located within the sensor range is permitted to collect sensor data on behalf of the user, then the sensor may begin collecting data describing the ambient environment and storing it as sensor data in the user registration database.

Collecting sensor data from the sensor 200 and providing the sensor data to the user device 204e may be done in any suitable manner. In some examples, the sensor 200 continually provides data to the server 204aor server application which is stored and updated as new data is received. A portion of the stored data is designated for the user or associated with the user in any manner. In another example, the sensor 200 is generally maintained inactive until the user device 204e moves into the sensor range 206b of the sensor 200. At that time, the server application communicates with the sensor 200 over any appropriate network to switch the sensor 200 into an active mode of operation and begin reporting sensor data to the server application. The sensor data received at the server application may be stored in association with the user or user device 204e.

The sensor data may be provided to the user device 204e in any suitable fashion. If the sensor data includes numerical information such as temperature data, the sensor data may be presented in tabular form showing multiple temperature readings at particular time or locations, or in bar chart form or graph form, showing time variation of the sensor data. If the sensor data includes audio data captured from a microphone, a live presentation of current sensor data may be made available to a speaker of the user interface of the user device 204e. Further, if such audio data has been recorded, the user may be given the option to play back a portion of the recorded data. The user device 204e may include audio processing circuitry such as a parametric equalizer and audio filters to control the reproduction of the presented sound. Such features may be accessed and controlled through the application 204f using the user interface of the user device 204e.

If the user configuration settings permit, a live presentation of the data being collected, such as a video stream, may be communicated to the user device 204e using the network address of the device in the user registration database 204c. In the example of FIG. 2B, a video image 204g is displayed by the application 204 f on a display of the user interface of the user device 204 e. The video image 204g is created from sensor data captured by one or more sensors along the roadway shown in the image. The server 204a or server application running on the server 204a compares data of the location 206a of the user device 204e in the vehicle with locations of camera sensors along the roadway or in the vicinity of the roadway. When the location 206a of the user device 204e matches a location of a camera sensor, the data from the camera sensor may be offered and provided to the application 204f. The data from the camera sensor is used to form the video image 204g on the user interface by the application 204 f.

Any suitable degree or type of matching may be used, such as determining a matching zone defined by the sensor location and the sensor range 206b and identifying a match when the user location 206a falls within the matching zone. Sensor range may be defined in two dimensions (i.e., north-south-east-west) or three dimensions (i.e., adding elevation). Moreover, to account for motion of the user and user device 204e in a vehicle or other mobile user environment, a trajectory or course may be estimated or predicted for the location 206a of the user device 204e. The prediction may be based on current motion of the user device 204e as reported by the user device 204e to the user registration database 204c. In addition, the prediction may be based on past historical data for the user or user device 204e. In embodiments, the server 204a may implement an artificial intelligence or machine learning process to predict future locations of the user device 204e. For example, a machine learning model including a deep neural network may be trained on historical data including historical data about the locations visited by the user device 204e and subsequently used to predict user movement of the user device 204e.

Any suitable sensor may be accessed and its sensor data received or collected for provision to the user device 204e. In the illustrated example, the sensor data comes from a sensor 204i labelled or identified as Traffic Cam 1 in the image. The label or identifying information for a sensor such as the sensor 204i as displayed by the application 204f may be useful for the user as the user navigates through a region or navigates in the application 204f among available sensor data for the region. In another embodiment, the sensor data and image may come from another vehicle in traffic with the vehicle including the user device 204e. In some embodiments, as the user device 204e advances along a route, the sensor from which data is collected and presented to the user device 204e by the server application may be updated to provide an updated or current live view of the sensor data.

Furthermore, for certain types of sensors, the user's location relative to the sensor data being collected may be presented to the user. This can be accomplished since the user's location is known in relation to the location of the sensor. So, for example, in the video stream embodiment shown in FIG. 2B, the user's location 204h may be highlighted within the data being presented to the user using overlay graphics or other means. For other types of sensors, this may be accomplished in other ways. For example, an estimated distance from the location 206a of the user device 204e to the location 206a of a sensor such as sensor 200 may be presented as it relates to the presentation of the sensor data. The highlighting or otherwise embellishing the user's location in the image may be done in any suitable fashion, such as by displaying a graphical overlay on the image. The highlighting may be selectable by the user using the application 204f. The display of the user's location enables the system 204 to visually relate where the user is in the environment for the benefit of the user of the system 204.

FIG. 2C depicts an illustrative embodiment of a user display 210 that may be produced by the system 204 of FIG. 2B in accordance with various aspects described herein. The user display 210 is shown as presented by or produced by the application 204f on user device 204e located in user environment 204d. The user environment 204d is this exemplary embodiment is a vehicle.

As the user travels in the vehicle, the user display 210 presents a map view on the user device 204e. The map view of user display 210 shows the location 210a of the user device 204e, along with one or more sensors that are actively engaged and collecting ambient environment data for the user. In the example, a first sensor 210b labelled Dash Cam 1, a second sensor 210c labelled Traffic Cam 1 and a third sensor 210d labelled Mic 1 are displayed on the user display 210. The first sensor 210b and the second sensor 210c correspond to camera sensors. The third sensor 210d corresponds to a microphone sensor.

The map view presented by the user display 210 provides another way for the user to visualize the location 210a of the user relative to one or more sensors in the user's ambient environment. As the user travels, the ability of sensors to capture information about the user's ambient environment varies, including variation with the availability of sensors. Thus, in a busy urban environment with many sensors in the environment, there are plenty of opportunities for the system 204 to be very specific about being able to represent user information that shows information such as the user's location 210a and locations of sensors 210b, 210c, 210d. For example, if the user is interested in sensors that measure and report air quality at a location, such sensors are likely to be more prevalent in an urban location where air quality is a more pressing issue. In contrast, a rural environment is likely to have many fewer sensors and fewer air quality sensors available to the user.

Further, the ability of the system 400 to measure or report on an environment can change with time as well, including sometimes quite rapidly. For example, if a dashcam sensor such as the first sensor 210b in FIG. 2C is used for providing images to a user at location 210a, the dashcam sensor can participate in the system 204 for only a few moments as the vehicle employing the dashcam sensor moves into the ambient environment and out of the ambient environment. Thus, the system 204 enables the user to learn at any time or any location the current capabilities for the user to collect data about the current user location.

In some embodiments, the user may also optionally use the view of user display 210 to control activity and permissions of each sensor. For example, the user may activate or deactivate each sensor for the purpose of collecting and storing data on behalf of the user. Interaction with the user display 210 may be by touching the touch-sensitive display on which the user display 201 is shown. By touching an object on the touch-sensitive display, the user may select the network component associated with that displayed object. The application 204f may in turn retrieve from the server 204a information about the sensor including optional settings. The interface provided in FIG. 2C may also be used to discover other sensors that the user may wish to activate. For example, the user may touch the Mic 1 icon of the third sensor 210d in order to activate the microphone sensor to begin collecting ambient data. A further touch may disable or deactivate the microphone sensor.

Thus, in an example, the user touches the Dash cam 1 icon associated with the dash cam sensor, first sensor 210b, and sees the image captured by the dashcam of the vehicle as the vehicle is in the vicinity of the location 210a of the user. Further, the user touches the Mic 1 icon associated with the third sensor 210d and hears the sounds collected by the microphone sensor at that location. After viewing or hearing the respective sensor data, the user may select a return icon to return to a base view such as is shown in FIG. 2C. Operation of the system 204 assumes that owners of, for example, the first sensor 210b of the dash cam have given permission for collection and distribution of their data.

FIG. 2D depicts an illustrative embodiment of a user display 212 produced by the system 204 of FIG. 2B in accordance with various aspects described herein. The user display 212 is shown as presented by or produced by the application 204f on user device 204e located in user environment 204d. The user environment 204d is this exemplary embodiment is a vehicle.

As the user travels in the vehicle, the user display 212 presents a map view on the user device 204e. The map view of user display 212 shows the location 210a of the user device 204e, labelled ME in FIG. 2D, along with one or more sensors that are actively engaged and collecting ambient environment data for the user. In the example, the user display 212 shows a camera sensor 212b, a camera sensor 212c, a camera sensor 212d, a camera sensor 212e, and a camera sensor 212f. The sensors are in a map area 212g.

Thus, FIG. 2D and user display 212 provide another visualization of active sensors for the user in a different map view format on the user device 204e. The user display 212 shows the location 212a of the user. The user display 212 further creates an ambient bubble that corresponds to map area 212g and that describes a range of sensors within which ambient data may be collected or is being collected for the user at any given point in time. That is, this ambient bubble represents an additive area throughout which data is collected for the user by the sensors with which the user has engaged. The size and shape of the ambient bubble for the user will continually change as the user's location changes within its ambient environment. This continually changing ambient bubble may therefore be presented as updated images on the user device. The user may select any sensor device icon as shown to begin a stream of the data collected by the sensor to be presented to the user by the application 204f on the user device 204e.

Thus, the ambient bubble associated with map area 212g may be considered a morphing shape on the map that exists and varies over time based on where the user and user device 204e are and what sensors are near the location 212a of the user device. The ambient bubble of the map area 212g shown on the map view may give the user information about how long or in what areas the user is going to continue to be able to collect what types of data. If the user moves from the location 212a in any direction, the ambient bubble that is displayed may change shape as some available nearby sensors become too far away and drop off the map area 212g and some other available sensors move into proximity to the user location and become available. Further, if sensors are mobile such as a dashcam in a moving vehicle providing a view, the shape of the ambient bubble may evolve over time as the dashcam sensor moves near to the location 212a of the user device 204e and away from the user device 204e.

FIG. 2E depicts an illustrative embodiment of a user display 214 produced by the system 204 of FIG. 2B in accordance with various aspects described herein. The user display 214 is shown as presented by or produced by the application 204f on user device 204e located in user environment 204d. The user environment 204d is this exemplary embodiment is a vehicle.

As the user travels in the vehicle, the user display 214 presents an augmented reality (AR) view on the user device 204e. Augmented reality is a technology that overlays digital information onto an image of the real world, enhancing the user's perception of reality. AR differs from virtual reality (VR) which creates a completely artificial environment.

The user display 214 thus presents a visualization of active sensors in the vicinity of the location to provide an augmented view of what is to be seen at the user's location. Thus, the user device 204e may be used to present the AR display similar to FIG. 2E. The AR display of user display 214 may include a summary or compilation of the data available that is being collected by cameras and other sensors on behalf of the user. The AR image displayed by user display 214 may be assembled or composed from information received by the system from sensors in the area. Thus, the AR image displayed by the user display 214 may not be the actual view seen by any one sensor but be a constructed image presented “as if” the user were at that particular location. In this manner, as in the example as shown, the user may be able to visualize the locations within the user's ambient environment that are included by sensor data collection.

The user display 214 in the particular example includes a steering wheel 214a and dashboard 214b in the foreground, roadway 214c in the middle distance and mountains 214d in the far distance, seen through a virtual windshield. The image out the virtual windshield may be visually divided into multiple regions corresponding to sensor coverage. Thus, a first region 214e is labelled in the user display 214 as having “5 camera angles available” and a second region 214f is labelled in the user display 214 as having “1 camera angle available.”

In some embodiments or applications then, the user display 214 may be viewed as an AR presentation of the user's ambient bubble as illustrated in map area 212g of FIG. 2D. So, for example, at one layer of the user's ambient bubble, the user may have five camera sensors or other sensors available to collect information on the user's behalf, such as is shown in first region 214e in FIG. 2D. The user is in motion, for example, driving or riding in a vehicle. At an upcoming location, such as in second region 214f, the ambient data collection specificity will change such that only one sensor will be available within the bubble. It may occur that, in the upcoming location of second region 214f, more sensors will become available because of greater proximity to the user location. As the user and user device move closer, they move into range of more sensor locations and the server 204a finds a match among the sensor registration database 204b and the user registration database 204c (FIG. 2B).

FIG. 2F depicts an illustrative embodiment of a user display 216 produced by the system 204 of FIG. 2B in accordance with various aspects described herein. The user display 216 is shown as presented by or produced by the application 204f on user device 204e located in user environment 204d. The user environment 204d is this exemplary embodiment is a vehicle.

The user display 216 shows a map view including a map area 216b surrounding a virtual location 216a of a user 216c. The map view further shows locations of four camera sensors including first sensor 216d, second sensor 216e, third sensor 216f and fourth sensor 216g.

In some embodiments, a user 216c may also use the system 204 to identify and engage with a set of sensors at a remote location, designated virtual location 216a. The user 216c may, for instance, via speech input or other input to a user interface of the user device 204e, specify a virtual location for the user device 204e, as illustrated in this example by the speech bubble 216h in FIG. 2F. The user asks to see the view “at the entrance to the park.” In some embodiments the user request from the user 216c causes the location of the user registration database 204c (FIG. 2B) to be temporarily set to the virtual location 216a as specified in response to the user request. For example. the current user location in the user registration database 204c may be set to the virtual location 216a for temporary processing and evaluation.

In exemplary embodiments, the system 204 then compares the sensor range for the various sensors including first sensor 216d, second sensor 216e, third sensor 216f and fourth sensor 216g that are registered in the sensor registration database 204b with the virtual location 216a of the user. In response to the comparison, the system 204 may present user display 216 with a map showing a virtual ambient bubble corresponding to map area 216b for the user and accessible sensors as shown.

Thus, the embodiment of FIG. 2F allows the user 216c to virtually place the user in a desired location. Rather than just viewing the area around the current location of the user 216c, the user can receive sensor data for the desired location. While camera sensor data is shown in the illustrated examples, any data from any sensor may be accessed. Moreover, sensor data from a past time may be accessed. For example, if the user 216c visited the virtual location 216a in the past, the user 216c may request that the system 204 replay camera sensor or other data from that time to view or experience the location in the past.

FIG. 2G depicts an illustrative embodiment of a user display 218 produced by the system 204 of FIG. 2B in accordance with various aspects described herein. The user display 218 is shown as presented by or produced by the application 204f on user device 204e located in user environment 204d. The user environment 204d is this exemplary embodiment is a vehicle.

The user display 218 shows a map view of a park and a location of a camera sensor 218a. Further, the user display 218 shows an image 218b from the camera sensor 218a. In the example, a user 218c accesses the user device 204e and requests a view from a particular location, such as the entrance to the park, as indicated by the speech bubble 218d in FIG. 2G.

Thus, in accordance with this exemplary embodiment, the user 218c may use the icon representations of the locations of the sensors such as camera sensor 218a within the virtual ambient bubble to control access or presentation to the user 218c of the ambient environment data in real time or for storage for later consumption for the user 218c. In accordance with the embodiment of FIG. 2G, then, the user 218c may use the system to specify a location and see or otherwise experience sensor data from that location for the current time, or for a real-time view. In accordance with the embodiment of FIG. 2H, the user may request a playback of past sensor data. The playback request may be provided to and processed through a user interface of the application 204f.

FIG. 2H depicts an illustrative embodiment of a user display 220 produced by the system 204 of FIG. 2B in accordance with various aspects described herein. The user display 220 is shown as presented by or produced by the application 204f on user device 204e as used by a user 220a.

The user display 220 shows a menu view 220c of selections for playback by the user 220a. The user 220a may request a particular item for playback, as indicated by the speech bubble in FIG. 2H. The menu view 220c includes in this example two menu items, including a first menu option 220d to play back video from a playground camera sensor and a second menu option 220e to play back video from a lake camera sensor. In embodiments, the menu items may include thumbnail images or other information about the data corresponding to the menu item. The menu view 220c is produced on the user display 220 by the system 204 in response to the user command to “playback our visit to the park last summer.”

Thus, in exemplary embodiments, at any point later in time, the user 220a may request a playback of saved sensor data. The user request may specify, for example, a location and a time. The location may be approximate, and the time may be a time range or an approximate time. The application 204f may provide a search function for the user to locate stored sensor data of interest. The system 204 and the application 204f may provide a presentation of the saved data in whatever form it may take to the user 220a, within the application 204f. In the embodiment presented in FIG. 2G, for example, if the user 220a decided to visit the park, the user 220a may wish to play back stored video or audio that was captured by sensors in the ambient environment around the user device 204e during the visit. Therefore, the available stored ambient data may be presented to the user for playback.

FIG. 2I depicts an illustrative embodiment of a method 230 in accordance with various aspects described herein. The method 230 may be performed at any suitable device in a network of data processing systems. In some embodiments, the method 230 may be performed at a network node of a communication network such as the communications network 125 of FIG. 1. In an example, the method 230 may be performed at a network node including a data processing system having a processor and memory and responsive to instructions to implement the method 230. In some embodiments, the method 230 may be implemented by an ambient sensor control server in data communication with a plurality of ambient environmental sensors. The method 230 may be initiated in response to any suitable input, including activation by a user requesting access to sensor information or activation by a system to begin collecting sensor information from sensors in data communication with the network.

At step 232, the method 230 includes collecting and storing sensor location data. In embodiments column the stored data may include information about a location of the sensor, a type of sensor, such as a camera sensor, temperature sensor, or others, sensor range information defining a range of activation of the sensor, a network address for the sensor, and any other available information characterizing the sensor. The information may be automatically reported by the sensors, or may be collected by the network node, for example, by polling the sensors. The sensor information may be stored in any suitable location, such as a sensor registration database, for ready access and updating.

At step 234, method 230 includes receiving user location data for user devices writing in the system. The user location data may include a user identifier, location information for a current location of the user device, timestamp information for the location information, and a network address where the user device may be accessed. Any other suitable or available information for the user device may be received. The user information may be stored in any suitable location, such as a user registration database, for ready access and updating but the network node.

At step 236, method 230 includes determining if received user location information matches a sensor location. Any suitable matching criteria may be used. In a first example, the method 230 includes determining the current location for the user device and an anticipated future location or trajectory for the user device, and determining if such locations match locations of one or more sensors as stored in the sensor registration database. In another example, sensor locations are extended by the sensor range information stored in the sensor registration database. This may form a sensor range defining a two-or three-dimensional space around the sensor in which the sensor may be active as it involves the user device. The current or future location of the user device may be compared with the sensor range to determine if the user device currently or will intersect with the sensor range for one or more sensors. If there is no match, control returns to step 234 to continue receiving updated user location information. As the user device moves through the network, user location information may be provided and updated according to any schedule or period.

At step 238, if there was a match between a user location and a sensor location, the method 230 includes messaging one or more sensors to begin collecting data. A control message may be sent to one or more sensors having a sensor location that matches the user location or will match the user location in the near future, as determined, for example, at step 236.

At step 240, as data is collected from sensors, the method 230 includes advising a user associated with the user device of the availability of sensor data. Such advice to the user may take any format, such as a message displayed on a user interface of the user device or a response to a query from the user using the user device. In some embodiments, the user device may instantiate a software application which cooperates with a server application operating on an ambient sensor control server which controls the provision of sensor data to the user device.

At step 242, it is determined if the user requests sensor data as offered to the user at step 240. If not, control returns to step 234 to continue monitoring the user location. On the other hand, if the user requests sensor data, at step 244, the data may be presented to the user at the user device.

Presentation of user data may take any suitable form, depending in part, for example on the nature of the sensor data. For example, if sensor data includes temperature data, a graph may be displayed on a user interface of the user device showing variation in temperature as detected by the sensor over time. The user interface may include controls for the user to vary the display of particular data. In another example, the sensor data may include image data. The image data may include a single image, data from a file of video information, or a stream of video information. The images or video may be presented on a user display of the user device. Again, the user may have controls on the user interface for managing the display of the sensor data.

Other options may be available for display of, or presentation of, sensor data to the user. At step 246, it is determined if the user requests recorded sensor data. For example, if one or more sensors are generally active and collecting information, such as temperature information from a temperature sensor, audio information from a microphone sensor, or images from a camera sensor, the sensor data may be automatically reported to the network node and stored for subsequent access. The user may be given the option to access and view this stored, recorded data from a previous time period. In one example, the user interface may provide a search interface for the user to locate and access data from a particular sensor at a particular time that is of interest to the user. In return, at step 250, the stored data may be presented to the user in response to the user request. If the user does not request stored data at step 246, operation of the method 230 may continue at step 248.

In accordance with another optional feature, at step 252, the user may request sensor data for a virtual location. In an example, the user may specify a location of interest on a map by touching a touch sensitive display shown on the user interface of the user device and requesting sensor data for the touched location. In another example, the user may use voice commands or data entry to specify a particular location where data from sensors is of interest. In response, at step 254, the method 230 includes presenting to the user the requested data for the requested virtual location. This may include, for example, comparing the virtual location specified by the user with location and range information of sensors having data stored in a sensor data registration database. Any matching locations are used to select sensor data for provision to the user. The user request may specify a sensor data type of interest, such as video data, temperature data, or others, or the method 230 may provide to the user a menu of sensor available at the virtual location for selection by the user. Following the provision of the sensor data to the user for the virtual location, or if the user does not request such data, processing continues at step 248.

While for purposes of simplicity of explanation, the respective processes are shown and described as a series of blocks in FIG. 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

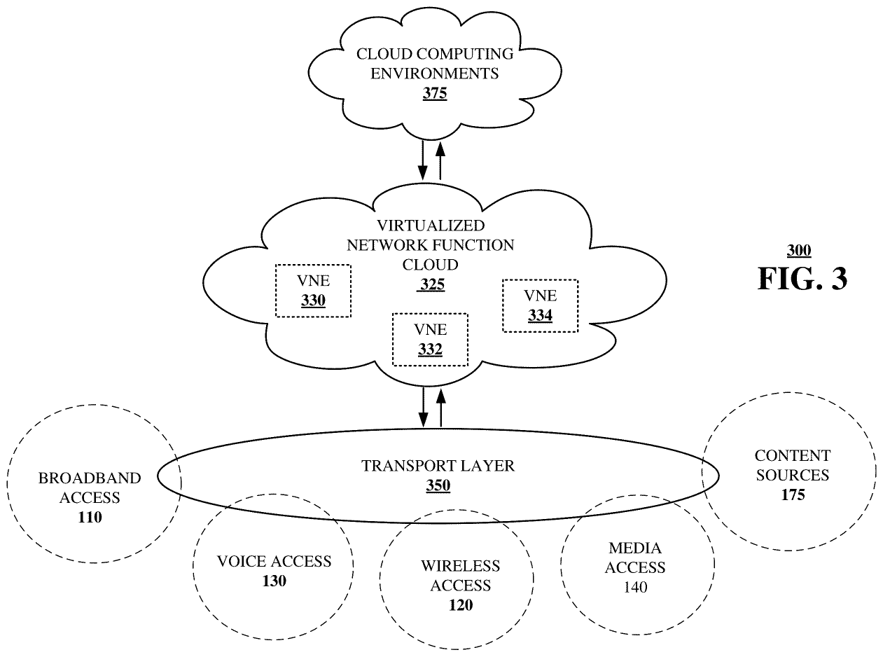

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 204, and method 230 presented in FIG. 1, FIG. 2A, FIG. 2B, FIGS. 2C through 2I, and FIG. 3. For example, virtualized communication network 300 can facilitate in whole or in part identifying a group of sensors accessible over a network and which a user can identify and instruct the network to engage and collect data describing the ambient environment of the sensors for access by the user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

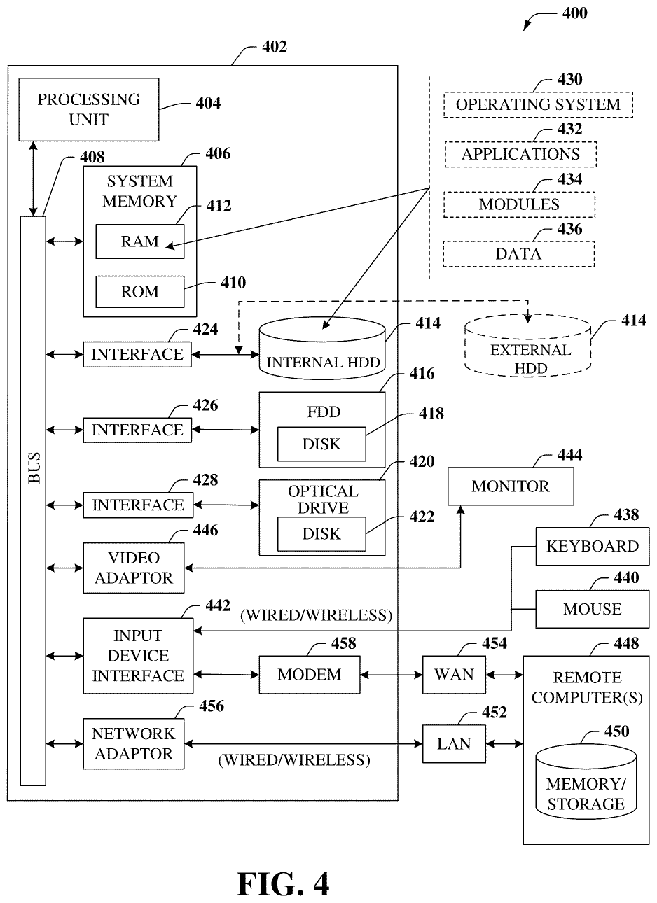

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identifying a group of sensors accessible over a network and which a user can identify and instruct the network to engage and collect data describing the ambient environment of the sensors for access by the user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

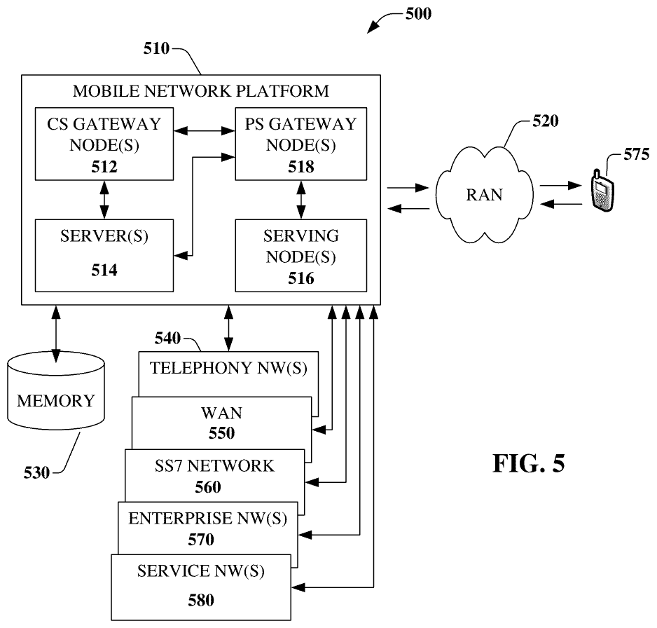

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identifying a group of sensors accessible over a network and which a user can identify and instruct the network to engage and collect data describing the ambient environment of the sensors for access by the user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

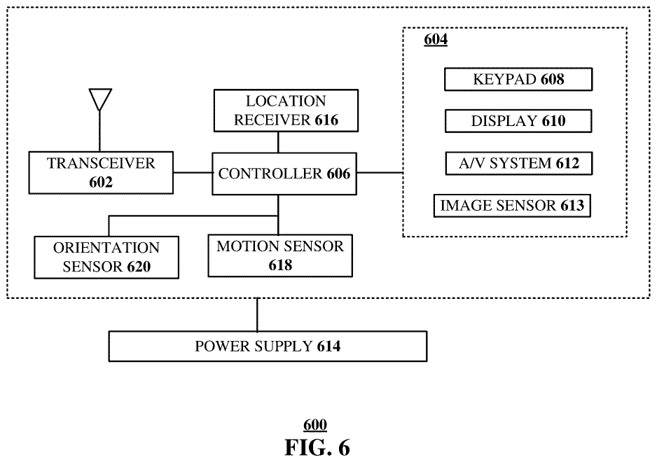

Turning now to FIG. 6, an illustrative embodiment of a communication device 600 is shown. The communication device 600 can serve as an illustrative embodiment of devices such as data terminals 114, mobile devices 124, vehicle 126, display devices 144, user device 204e or other client devices for communication via either communications network 125. For example, communication device 600 can facilitate in whole or in part identifying a group of sensors accessible over a network and which a user associated with a user device such as communication device 600 can identify and instruct the network to engage and collect data describing the ambient environment of the sensors for access by the user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth® . The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth® , or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor and a memory, sensor location data for one or more sensors;
receiving, by the processing system, user device location information for a user device;
determining, by the processing system, a match between the user device location information and sensor location data for at least one sensor of the one or more sensors;
collecting, by the processing system, sensor data from the at least one sensor; and
presenting, by the processing system, to the user device, information for display by the user device, the information for display indicating availability of collected sensor data from the at least one sensor.

2. The method of claim 1, further comprising:
presenting, by the processing system, to the user device, data defining a visual representation of a local environment of the at least one sensor.

3. The method of claim 2, further comprising:
determining, by the processing system, the data defining the visual representation of the local environment based on the sensor data from the at least one sensor.

4. The method of claim 3, wherein the collecting sensor data from the at least one sensor comprises:
receiving, by the processing system, image data from a camera sensor.

5. The method of claim 4, wherein the receiving image data comprises:
receiving, by the processing system, from a plurality of camera sensors, image data showing at least a portion of a location corresponding to the user device location information for the user device.

6. The method of claim 1, comprising:
presenting, by the processing system, to the user device, the information for display by the user device at substantially a same time the sensor data from the at least one sensor is collected.

7. The method of claim 1, further comprising:
receiving, by the processing system, a user request to display recorded sensor data;
retrieving, by the processing system, from the memory, historical data corresponding to the user request to display recorded sensor data; and
presenting, by the processing system, to the user device, the historical data, wherein the historical data defines a visual representation of a local environment of the at least one sensor.

8. The method of claim 1, comprising:
receiving, by the processing system, a user request to display image data for a requested location; and
presenting, by the processing system, to the user device, data defining a visual representation of a local environment of the requested location.

9. The method of claim 8, wherein the receiving the user request to display image data for the requested location comprises:
receiving, by the processing system, a user request to display image data for a current user device location, wherein the current user device location is associated with the user device location information.

10. The method of claim 8, wherein the receiving the user request to display image data for the requested location comprises:
receiving, by the processing system, from the user device, information defining a virtual location of interest to a user associated with the user device.

11. A device, comprising:
a processing system including a processor; and
a memory that stores executable instructions that, when executed by the processing system, facilitate performance of operations, the operations comprising:
receiving sensor location data for a plurality of sensors, wherein the sensor location data defines respective locations for respective sensors of the plurality of sensors;
receiving user device location information for a user device;
matching the user device location information with sensor location data for one or more sensors of the plurality of sensors to identify sensors having sensor information for an environment of the user device;
requesting sensor data from the one or more sensors of the plurality of sensors;
receiving the sensor data from the one or more sensors of the plurality of sensors;
and providing, to the user device, display information for producing a display on a user display of the user device, the display providing a visual representation of the sensor data, wherein the providing the display information is based on the sensor data from the one or more sensors of the plurality of sensors.

12. The device of claim 11, wherein the operations further comprise:
receiving, from the user device, a user command for controlling at least one sensor of the one or more sensors; and
providing, to the at least one sensor, a control command based on the user command for controlling the at least one sensor.

13. The device of claim 11, wherein the providing display information for producing the display on the user display of the user device comprises:
receiving camera sensor data from the one or more sensors of the plurality of sensors;
compiling the camera sensor data to form an augmented reality image of a location, forming AR data; and
providing the AR data to the user device, the user device responsive to the AR data to form an augmented reality display of the location.

14. The device of claim 11, wherein the operations further comprise:
determining sensor range data for a plurality of sensors, the sensor range data defining an activation range for the respective sensors of the plurality of sensors, the activation range corresponding to a range of locations at which a respective sensor is able to capture sensor data;
matching the user device location information with the sensor range data to identify proximate sensors; and
providing, to the user device, captured sensor data from the proximate sensors, wherein the providing the captured sensor data is responsive to the matching the user device location information with the sensor range data.

15. The device of claim 11, wherein the operations further comprise:
predicting a future user location, wherein the predicting the future user location is based on at least one of the user device location information and historical user information;
matching the future user location with sensor location data for at least one sensor of the plurality of sensors to identify sensors having sensor information for a future environment of the user device;
determining that the user device is proximate the at least one sensor of the plurality of sensors; and
requesting sensor data from the at least one sensor of the plurality of sensors for provision to the user device.

16. A non-transitory machine-readable medium, comprising executable instructions that, when executed by a processing system including a processor, facilitate performance of operations, the operations comprising:
receiving user device location information for a user device;
determining a match between the user device location information and sensor location data for at least one sensor of a group of one or more sensors, the one or more sensors configured to collect information about an environment including a respective sensor; and
communicating, to the user device, information for display by the user device for a user, the information for display indicating availability of collected sensor data from the at least one sensor.

17. The non-transitory machine-readable medium of claim 16, wherein the operations further comprise:
receiving, from the user device, a request for sensor data;
receiving sensor data from the at least one sensor, forming current sensor data;
and providing, to the user device, in response to the request for sensor data, the current sensor data, wherein the current sensor data includes image data, the image data producing on the user device an image showing at least a portion of a location corresponding to the user device location information for the user device.

18. The non-transitory machine-readable medium of claim 16, wherein the operations further comprise:
receiving, from the user device, a request for recorded sensor data, the request for recorded sensor data including information identifying a sensor location and time information;
retrieving, from storage, in response to the request for sensor data, the recorded sensor data according to the information identifying the sensor location and the time information; and
providing the recorded sensor data to the user device.

19. The non-transitory machine-readable medium of claim 16, wherein the operations further comprise:
receiving sensor location data for the group of one or more sensors, the sensor location data defining respective locations for respective sensors of the group of one or more sensors; and
matching the user device location information for the user device with the sensor location data for the group of one or more sensors to identify sensors having sensor information for an environment of the user device.

20. The non-transitory machine-readable medium of claim 16, wherein the operations further comprise:
predicting a future user location of the user device;
matching the future user location with sensor location data for at least one sensor of the group of one or more sensors to identify sensors having sensor information for a future environment of the user device;
determining that the user device is proximate the at least one sensor of the group of one or more sensors; and
requesting sensor data from the at least one sensor of the group of one or more sensors for provision to the user device.
